(19) United States
(12) Patent Application Publication
(10) Pub. No.: US 2020/0033474 A1
(43) Pub. Date: Jan. 30, 2020

(54) LIDAR SYSTEM WITH FLEXIBLE SCAN PARAMETERS

(71) Applicant: Blickfeld GmbH, Muenchen (DE)

(72) Inventor: Florian Petit, Muenchen (DE)

(21) Appl. No.: 16/491,884

(22) PCT Filed: Mar. 8, 2018
(86) PCT No.: PCT/DE2018/100212

§ 371 Date: Sep. 6, 2019

(30) Foreign Application Priority Data
Mar. 8, 2017 (DE) 10 2071 000 235.6

(51) Int. Cl. G01S 17/10; G01S 17/42; G01S 7/481; G01S 7/484; H01S 3/00

(52) U.S. Cl. CPC G01S 17/10; G01S 17/42; H01S 3/005; G01S 7/484; G01S 7/4817

(57) ABSTRACT

The invention relates to a LIDAR system (100) comprising a laser scanner (101) with at least one laser light source (111), The laser scanner (101) is designed to emit laser pulses (191) into multiple angular regions. A controller is designed to actuate the at least one laser light source (111) in order to emit at least one first laser pulse (191) into a specific angular region and to carry out a LIDAR measurement on the basis of a reflection (192) of the at least one first laser pulse (191). The controller (102) is additionally designed to change at least one scan parameter of the laser scanner (101) on the basis of the LIDAR measurement and to then selectively actuate the at least one laser light source (111) so as to emit at least one second laser pulse (191) into the specific angular region.

### TECHNICAL AREA

Various examples of the invention relate to a LIDAR system having a laser scanner, which is designed to emit laser pulses into multiple angular regions. The LIDAR system also comprises a controller, which is designed to change at least one scan parameter of the laser scanner on the basis of a LIDAR measurement.

### BACKGROUND

The distance measurement of objects is desirable in various fields of technology. For example, it can be desirable in connection with applications of autonomous driving, detecting objects in the environment of vehicles, and particularly in determining a distance to objects.

One technology for the distance measurement of objects is the so-called LIDAR technology (known as light detection and ranging or sometimes also LADAR in English). In this process, pulsed laser light is emitted from an emitter. The objects in the environment reflect the laser light. These reflections can then be measured. By determining the travel time of the laser light, a distance to objects can be determined.

In order to detect the objects in the environment with spatial resolution, it may be possible to scan the laser light. Depending on the angle of radiation of the laser light, different objects in the environment can thereby be detected. Laser scanners can be used for the scanning. The laser scanners can be operated, for example, mechanically; see, e.g., U.S. Pat. Nos. 5,006,721 A or 8,446,571 B2. Solid-state-based laser scanners based on constructive or destructive interference of light are also known; for example, see US 20160049765A1.

In some application cases, LIDAR technologies are used in vehicles, for example personal motor vehicles. Thus, techniques of autonomous driving, for example, can be implemented. In general, various driver assistance functionalities are conceivable based on LIDAR data with distance and/or depth information. For example, objects in the corresponding LIDAR images can be detected.

Such predetermined technologies have certain limitations and disadvantages. Oftentimes, it may be necessary to ensure certain requirements in reference to eye safety. This is necessary so as to not endanger people in the environment. In addition, it can sometimes be necessary to consider certain physical limitations of the laser light sources used. For example, it may be necessary to maintain a certain repetition rate in order to prevent damage to the laser light source due to heat.

With the known technologies, a trade-off consideration can often be made with reference to repetition rate and eye safety. In many examples, this can limit the performance of the LIDAR system, for example as relates to resolution or range.

### BRIEF DESCRIPTION OF THE INVENTION

Therefore, there is a need for improved technologies regarding distance measurement by means of LIDAR systems. In particular, there is a need for such technologies which eliminate at least some of the aforementioned disadvantages or limitations.

This object is achieved with the features of the independent claims. The features of the independent claims define embodiments.

A LIDAR system comprises a laser scanner with at least one laser light source. The laser scanner is designed to emit laser pulses into multiple angular regions. The LIDAR system also comprises a controller. The controller is designed to actuate the at least one laser light source so as to emit at least one first laser pulse into a specific angular region from multiple angular regions. The controller is additionally designed to implement a LIDAR measurement based on a reflection of the least one first laser pulse. The controller is additionally designed to change at least one first laser pulse of at least one scan parameter of the laser scanner on the basis of the LIDAR measurement and to then selectively actuate the at least one laser light source so as to emit at least one second laser pulse into the specific angular region.

The at least one first laser pulse can thus be characterized as a probe pulse, because it may be possible to change and/or to adapt one or more scan parameters of the laser scanner based on information that is obtained from the reflection of the at least one first laser pulse.

A flexible adaptation of the scanning of the environment can be enabled by means of such technologies. In particular, a balancing among different target variables such as, for example, technical limitations of the at least one laser light source—for example with reference to repetition rate, duty cycle, pulse power, operating temperature, etc.—eye safety and range can be flexibly adjusted.

By means of the technologies described herein, it is particularly possible to collect a priori knowledge regarding the specific angular region by means of the LIDAR measurement itself. In particular, a change of the at least one scan parameter can take place especially quickly in this manner, e.g. in comparison to more complex technologies, which are based on sensor fusion with other types of sensors.

In doing so, the most varied of scan parameters can be changed in the various examples described herein. Examples include a strength of the laser pulse, a repetition rate of the laser pulse, and an angular velocity, at which the laser scanner emits laser pulses into different angles of the multiple angular regions. For example, the strength of the laser pulse could be adjusted by means of an amplitude or output of the laser pulse. It would also be possible to adjust the strength of the laser pulse by means of duration of the pulse. The angular velocity can be correlated with a scanning speed. The repetition rate can correlate with the angular velocity via a scanning speed. Other scan parameters would also be conceivable however, for example the geometry of a superimposed frame of the scanning into a first and second scanning axis.

Furthermore, it is possible, in the different examples described herein, to consider various types of LIDAR measurements in correlation with the changing of the at least one scan parameter. In a simple implementation, the LIDAR measurement may relate to an intensity or travel time of the reflection of the at least one first laser pulse. A distance of an object in the environment can then be estimated for example. For example, it would be possible to select a larger (smaller) strength for the at least one second laser pulse for larger (smaller) distances of objects in the environment, which have been determined based on the intensity and/or the travel time of the reflection of the at least one laser pulse. Such technologies can be based on the knowledge that it may be desirable, with objects in the environment at a small distance, to limit the strength of the at least one second laser pulse in order to ensure eye safety. Correspondingly, the angular velocity could also be increased so that fewer laser pulses are present per solid angle. On the other hand, with objects in the environment at a larger distance, it may be desirable to select a greater strength of the at least one second laser pulse in order to precisely measure objects in the environment far away as well. For example, it would be possible for the controller to be designed to increase the strength of the at least one second laser pulse in the range of one or more orders of magnitude.

For example, if sufficient information regarding the corresponding objects in the environment has already been collected based on the LIDAR measurement of the reflection of the at least one first laser pulse, it may be entirely unnecessary to emit the second laser pulse. The strength of the at least one second laser pulse can then be selected to equal 0% of the strength of the at least one first laser pulse.

A method comprises the actuation of at least one laser light source of a laser scanner for emitting at least one first laser pulse into a specific angular region from multiple angular regions. The method also comprises the implementation of a LIDAR measurement based on a reflection of the least one first laser pulse. The method also comprises the modification of at least one scan parameter of the laser scanner based on the LIDAR measurement. The method also comprises the selective actuation of the at least one laser light source in order to emit at least one second laser pulse into the specific angular region.

The previously described examples and technologies can also be combined with one another in other examples.

### BRIEF DESCRIPTION OF THE FIGURES

FIG. 1 schematically illustrates a LIDAR system with a laser scanner and a controller according to various examples.

FIG. 2 schematically illustrates the laser scanner in greater detail and according to various examples.

FIG. 3 is a flowchart of an exemplary method.

FIG. 4 illustrates angular regions, into which the laser scanner can emit laser pulses according to various examples.

FIG. 5 schematically illustrates the modification of an arrangement of angles, at which the laser scanner emits laser pulses, based on a LIDAR measurement according to various examples.

FIG. 6 schematically illustrates the modification of an arrangement of angles, at which the laser scanner emits laser pulses, based on a LIDAR measurement according to various examples.

FIGS. 7-9 schematically illustrate the modification of a strength of laser pulses, based on a LIDAR measurement according to various examples.

FIG. 10 schematically illustrates the modification of an angular velocity, at which the laser scanner scans the environment, according to various examples.

FIG. 11 schematically illustrates a time interval, according to various examples, between laser pulses, which have been emitted according to different scan parameters.

FIG. 12 schematically illustrates a time interval, according to various examples, between laser pulses, which have been emitted according to different scan parameters.

FIG. 13 schematically illustrates a time interval, according to various examples, between laser pulses, which have been emitted according to different scan parameters.

FIG. 14 is a flowchart of an exemplary method.

### DETAILED DESCRIPTION OF EMBODIMENTS

The previously described properties, features, and advantages of this invention as well as the type and manner as to how they are achieved will become more clearly and noticeably understandable in the context of the following description of the exemplary embodiments, which are explained in greater detail in connection with the drawings.

In the following, the present invention is explained in greater detail by means of preferred embodiments, with reference to the drawings. The same reference numerals refer to equivalent or similar elements in the figures. The figures are schematic representations of various embodiments of the invention. Elements shown in the figures are not necessarily shown to scale. Rather, the various elements shown in the figures are reflected such that their function and general purpose will be understandable to one skilled in the art. Connections and couplings between functional units and elements shown in the figures can also be implemented as a direct connection or coupling. A connection or coupling may be implemented wired or wirelessly. Functional units may be implemented as hardware, software, or a combination of hardware and software.

Various techniques for the scanning of laser light are described in the following. The subsequently described techniques can enable, for example, the one-dimensional or two-dimensional scanning of laser light. The scanning may characterize the emitting of laser pulses into different angles or angular regions. In doing so, the angular region may be scanned repeatedly. The repeated implementation of scanning of a specific angular region may determine a repetition rate of scanning. The quantity of the angular regions may define a scanning region and/or an image region. The scanning may characterize the repeated scanning of different scanning points in the environment by means of laser pulses. Measurement signals can be determined for each scanning point. In doing so, the reflection of a corresponding laser pulse in an object in the environment can be considered. Based on the measurement signals, a LIDAR measurement can be implemented.

For example, coherent or incoherent laser light can be used. It would also be possible to use polarized or unpolarized laser light. For example, it would be possible for the laser light to be pulsed. For example, short laser pulses with pulse lengths in the range of femtoseconds or picoseconds or nanoseconds can be used. The maximum output of individual pulses may be in a range of 50 W-150 W, particularly for pulse lengths in the nanosecond range. The strength of the laser pulses can be modified by changing such values. For example, a pulse duration can be in a range of 0.5-3 ns. The laser light may have a wavelength in a range of 700-1800 nm. For example, a solid-body laser diode can be used as the laser light source. For example, the SPL PL90_3 diode from OSRAM Opto Semiconductors GmbH, Leibnizstraβe 4, D-93055 Regensburg, Germany or a comparable solid-body laser diode could be used.

The scanning region is defined unidimensionally in various examples. This may mean, for example, that the laser scanner scans the laser light only along one single scanning axis by means of a deflector unit. The scanning region is defined bidimensionally in other examples. This may mean, for example, that the laser scanner scans the laser light along a first scanning axis and along a second scanning axis by means of the deflector unit. The first scanning axis and the second scanning axis are different from one another in this case. For example, the first and second scanning axis could be oriented orthogonally with respect to one another.

In some examples, a two-dimensional scanning region can be implemented by means of a single deflector unit having two or more degrees of freedom of movement. This may mean that a first movement of the deflector unit is effected according to the first scanning axis and a second movement of the deflector unit is effected according to the second scanning axis, for example, by means of an actuator, wherein the first movement and the second movement are superimposed in time and space.

In other examples, the two-dimensional scanning region may be implemented by more than one single deflector unit. It would then be possible, for example, for one single degree of freedom of movement to be induced for two deflector units. The laser light can first be deflected by a first deflector unit and then be deflected by a second deflector unit. The two deflector units can thus be arranged one after the other in the beam path. This means that the movements of the two deflector units are not superimposed in space. For example, a corresponding laser scanner may have two mirrors or prisms arranged apart from one another, which can be adjusted individually.

In various examples, it is possible for the laser scanner to implement resonantly different degrees of freedom of movement for scanning the laser light. Such a laser scanner is sometimes characterized as a resonant laser scanner. In particular, a resonant scanner may be different from a laser scanner that implements at least one degree of freedom of movement in increments (stepped). In some examples, it would be possible, for example, for a first movement—which corresponds to a first scanning axis—and a second movement—which corresponds to a second scanning axis which is different from the first scanning axis—to each be effected resonantly.

In other examples, a solid-body-based laser scanner may also be used by means of phase-coherent superimposition of multiple light sources.

In various examples, LIDAR techniques can be used. The LIDAR techniques can be used to implement a distance measurement of objects in the environment with spatial resolution. In various examples, the LIDAR technique can be implemented in connection with a driver assistance functionality for a motor vehicle. Therefore, a device containing the laser scanner may be arranged in the motor vehicle. For example, a LIDAR image could be created with depth resolution and provided to a driver assistance system of the motor vehicle, Thus, techniques of assisted driving or of autonomous driving, for example, can be implemented.

Various examples are based on the knowledge that an active adaptation of the scan parameters of the laser scanner can enable an optimum balancing between different target criteria such as, for example, eye safety, exposure to one or more laser light sources, and quality of a LIDAR image. Therefore, a controller of LIDAR system is designed to change at least one scan parameter of the laser scanner on the basis of a LIDAR measurement.

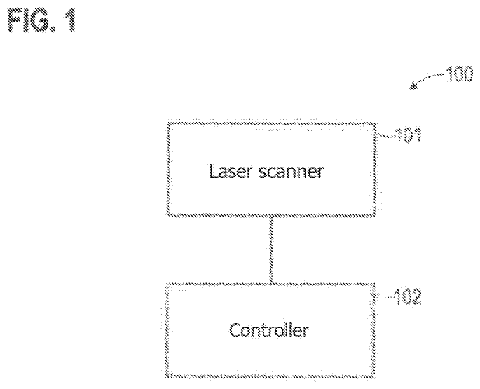

FIG. 1 illustrates aspects in relation to a LIDAR system 100. The LIDAR system 100 comprises a laser scanner 101. The laser scanner 101 is designed to emit laser light from one or more laser light sources in an environment of the device 100. In doing so, the laser scanner 101 is designed to scan the laser light at least along one scanning axis. In some examples, the laser scanner 101 is designed to scan the laser light along a first and a second scanning axis. For example, the laser scanner 101 may move a deflector unit resonantly, e.g. between two reversal points of movement. In doing so, a MEMS-based micromirror, for example, could implement the deflector unit. In other examples, the deflector unit could be moved continuously, e.g. as a rotating prism, etc.

The device 100 also comprises a controller 102. Examples of a controller 102 comprise an analog circuit, a digital circuit, a microprocessor, an FPGA, and/or an ASIC. The controller 102 can implement logic in order to ensure the operation of the laser scanner 101 with one or multiple scan parameters.

For example, the controller 102 can actuate the laser scanner 101. The controller 102 may adjust, for example, one or more scan parameters of the laser scanner 101. Examples of scan parameters comprise a strength of the laser pulses emitted, a repetition rate of the laser pulses, and an angular velocity. For example, a faster (slower) angular velocity could characterize a faster (slower) speed of the rotational movement of a rotating prism. For example, a faster (slower) angular velocity could characterize a larger (smaller) resonance frequency of a deflector unit operated resonantly.

For example, such scan parameters and other scan parameters can be changed as a function of a priori knowledge regarding one or more objects in the environment. For example, the a priori knowledge could be obtained from one or more preceding LIDAR measurements. For example, the controller may be designed to change at least one scan parameter of the laser scanner on the basis of a LIDAR measurement.

In doing so, different LIDAR measurements can be considered. The controller 102 may be designed, for example, to implement a distance measurement as a LIDAR measurement. To this end, the controller 102 can receive measurement signals from the laser scanner 101. These measurement signals and/or raw data may be indicative for a travel time of pulses of the laser light between transmitting and receiving; thus, they may relate to a reflection of laser pulses. These measurement signals may further indicate an associated angular region of the laser light. Based on this, the controller 102 can generate a LIDAR image, which corresponds, for example, to a scatter plot with depth information. Optionally, it would be possible for the controller 102 to implement, e.g., object detection based on the LIDAR image as a LIDAR measurement. For example, objects such as pedestrians, bicyclists, vehicles, buildings, vegetation, traffic signs, etc. could be detected.

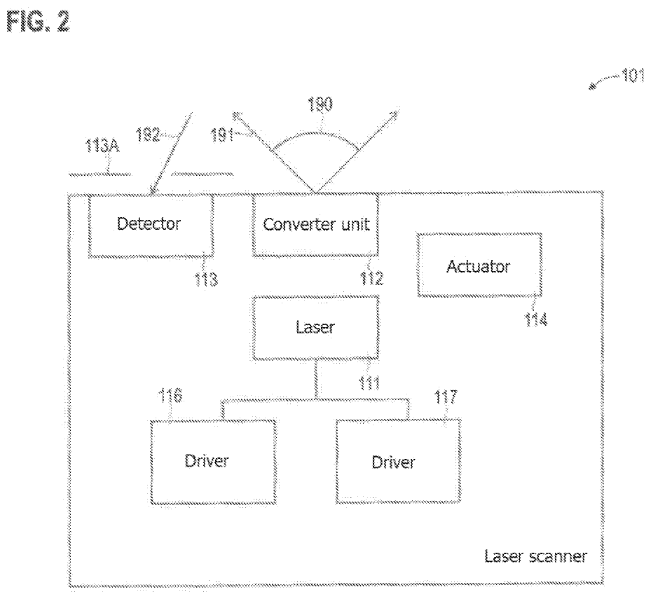

FIG. 2 illustrates aspects in relation to the laser scanner 101. In particular, FIG. 2 illustrates a laser scanner 101 according to various examples in greater detail than in FIG. 1.

In the example from FIG. 2, the laser scanner 101 comprises a laser light source 111. For example, the laser light source 111 may be a diode laser. In some examples, the laser light source 111 may be a vertical-cavity surface-emitting laser (VCSEL). The laser light source 111 emits laser pulses 191, which are deflected about a specific deflection angle by means of the deflector unit 112.

The laser light source 111 is actuated by means of two drivers 116, 117 in the example from FIG. 2. For example, the drivers 116, 117 may each have an electrical energy storage device, for example, of an inductance or a capacity. By discharging the electrical energy storage device, a current-voltage pulse can be transferred to the laser light source 111 as a driver signal, which is then converted into a laser pulse 191. Due to the provision of two drivers 116, 117, it may be possible to provide such driver signals, namely from different drivers 116, 117, very close to one another in time, for example within a few 10 ns or 100 ns. In particular, a time interval between successive laser pulses 191 may thereby be smaller than a duration that is required for charging the electrical energy storage device of a single driver 116, 117. In other examples however, only one individual driver or more than two drivers may be present.

The deflector unit 112 may comprise, e.g., a mirror or a prism. For example, the deflector unit 112 may comprise a rotating multi-facet prism. The deflector unit could be formed as an MEMS-based micromirror.

The laser scanner 101 may implement one or more scanning axes (in FIG. 2, only one scanning axis is shown, namely in the drawing plane). A two-dimensional scanning region can be implemented by providing multiple scanning axes. In order to scan the laser light 191, the deflector unit 112 has at least one degree of freedom of movement. Each degree of freedom of movement can define a corresponding scanning axis. The corresponding movement can be actuated and/or induced by means of an actuator 114.

In order to implement multiple scanning axes, it would be possible in some examples for more than one deflector unit to be present (not shown in FIG. 2), The laser pulses 191 can then go through the various deflector units sequentially. Each deflector unit may have a corresponding assigned degree of freedom of movement, which corresponds to a corresponding scanning axis. Sometimes, such an arrangement is characterized as a scanner system.

In order to implement multiple scanning axes, it would be possible in further examples for the individual deflector unit 112 to have more than one single degree of freedom of movement. For example, the deflector unit 112 could have at least two degrees of freedom of movement. Corresponding movements can be induced by the actuator 114. For example, the actuator 114 can induce the corresponding movements individually but simultaneously or coupled. It would then be possible to implement two or more scanning axes by effecting the movements superimposed in time and space. By superimposing the first movement and the second movement in space and time, an especially high integration of the laser scanner 101 can be achieved. The laser scanner 101 can thereby be implemented with a compact design. This enables flexible positioning of the laser scanner 101 in a motor vehicle. In addition, it is possible for the laser scanner 101 to have comparatively few components and thus be produced robustly and economically. If both the first movement and the second movement are effected periodically and continuously, a so-called superimposed figure, sometimes a Lissajous figure, can be obtained for scanning along the first scanning axis and the second scanning axis. The shape and geometry of the superimposed figure characterizes a scan parameter of the laser scanner 101.

In other examples, it would also be possible for there to be more than one laser light source 111. Different laser light sources 100 can then be arranged opposite one another and in relation to the deflector unit 112. A resolution along a scanning axis can also thereby be achieved.

In some examples, it is possible that at least the movement is effected resonantly for one scanning axis. It is also possible that at least the movement for one scanning axis is not effected resonantly but rather discretely and/or stepped.

The actuator 114 can typically be operated electrically. The actuator 114 could comprise magnetic components and/or piezo electric components. For example, the actuator may have a rotating magnetic field source, which is designed to generate a currently rotating magnetic field as a function. The actuator 114 could comprise, for example, piezo flexure components.

In some examples, an array made of multiple emitter structures—for example lightwave conductors—integrated on a substrate, such as silicon, can be used instead of a deflector unit 112, wherein the multiple emitter structures emit laser light in a specific phase relationship. By varying the phase relationship of the laser light which is emitted by the various emitter structures, a specific angle of radiation can then be set based on constructive and destructive interference. Such arrangements are also sometimes characterized as an optical array with a phase relationship (optical phased array, OPA). Refer to M. J. R. Heck, Highly integrated optical phased arrays: photonic integrated circuits for optical beam shaping and beam steering” in Nanophotonics (2016).

The laser scanner 101 also comprises a detector 113. For example, the detector 113 can be implemented by means of a photodiode. For example, the detector 113 can be implemented by means of a photodiode array and thus have multiple detector elements. For example, the detector 113 may have one or more single-photon avalanche diodes (SPAD).

The detector 113 is designed to detect laser pulse 192 reflections 192 generated from objects (not shown in FIG. 2) in the environment 100. Based on a travel-time measurement between the issuing of a 191 by means of the laser light source 111 and the detecting of the reflected laser pulse 192 by the detector 113, a distance measurement of the objects can then be implemented. Such techniques could also be combined or replaced, for example, with structured illumination, in which continuous laser light can be used instead of pulses of laser light 191.

In the example from FIG. 2, the detector 113 has its own aperture 113A. In other examples, it would also be possible for the detector 113 to use the same aperture that is also being used to emit the primary laser light 191. An especially high level of sensitivity can then be achieved.

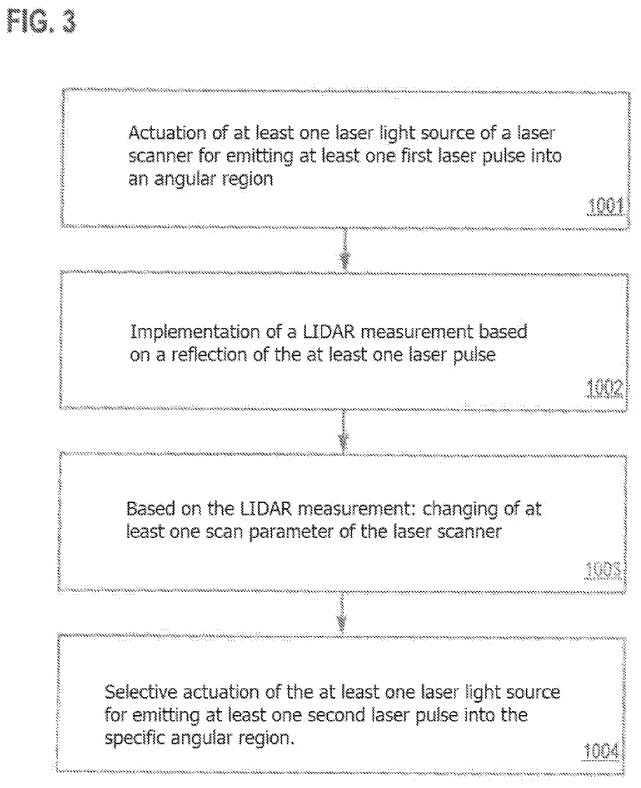

FIG. 3 is a flowchart of an exemplary method. Initially, at least one laser light source of a laser scanner is actuated to emit at least one first laser pulse into an angular region in 1001. The at least one laser pulse can be characterized as a probe pulse, which collects a priori information regarding objects in the angular region.

A LIDAR measurement based on a reflection of the at least one laser pulse from 1001 can then be implemented in 1002. To this end, measuring data from a detector can be read, for example.

For example, the LIDAR measurement could relate to at least one of an intensity and a travel time of the reflection of the at least one first laser pulse from 1001. A distance measurement can be implemented, for example, based on the travel time. It would also be possible to implement more complex measurements such as, for example, object detection.

Based on the LIDAR measurement from 1002, at least one scan parameter of the laser scanner is changed in 1003. For example, a strength of subsequent laser pulses could be changed. Alternatively or in addition, an angular velocity or scanning speed of the laser scanner could be used. Alternatively or in addition, a repetition rate at which the sequential laser pulses are emitted could be changed. Alternatively or in addition, a geometry of a superimposed figure could be changed for a laser scanner having two scanning axes.

The at least one laser light source is selectively actuated in 1004 to emit at least one second laser pulse into the same angular region into which the at least one laser pulse was emitted in 1001. In some examples, a suppression of the emitting of the at least one second laser pulse can take place such that the at least one laser light source is not actuated in 1004. The suppression of the emitting of the at least one second laser pulse can correspond to the setting of the strength of the at least one second laser pulse at 0% of the strength of the at least one first laser pulse.

In some examples, different laser drivers for providing a corresponding driver signal can be used for emitting the at least one first laser pulse in 1001 and the emitting of the at least one second laser pulse in 1004. This means that a time interval between the at least one first laser pulse and the at least one second laser pulse, i.e. 1001 and 1004, can be dimensioned especially minimally, for example no greater than 500 ns, optionally no greater than 200 ns, further optionally no greater than 150 ns.

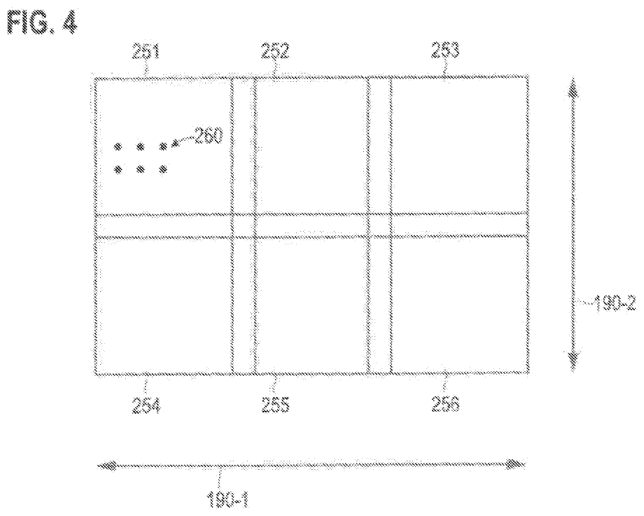

FIG. 4 illustrates aspects in relation to different angular regions 251-256. In the example from FIG. 4, the angular regions 251-256 are arranged with overlap. In other examples, the angular regions 251-256 may also be arranged without overlap. The quantity of the angular regions 251-256 defines scanning regions 190-1, 190-2; in the example from FIG. 4, two-dimensional scanning is shown.

By considering angular regions 251-256, it is possible for a priori knowledge for a specific angular region 251-256 to be considered for pulses emitted subsequently in this specific scanning region 251-256. It is thereby possible to select optimum scan parameters for different angular regions 251-256 for complicated measured tableaus as well, for example with many different objects and/or objects at various distances.

FIG. 4 additionally shows an example of scanning points 261 for angular region 251 (the scanning points have been omitted in the remaining angular regions 252-256 for the sake of simplicity). Each scanning point 261 in this case corresponds to a laser pulse 291, which has been emitted at an angle assigned to the scanning point 261. The scanning points 261 are arranged spaced apart from one another at a distance which is defined by the repetition rate of the corresponding laser pulses and the angular velocity of the laser scanner. A greater density of scanning points 261 can effect a higher resolution of a corresponding LIDAR image; on the other hand, the laser energy per solid angle can increase, which can influence eye safety. In addition, a greater repetition rate can lead to heating of the laser light source 111.

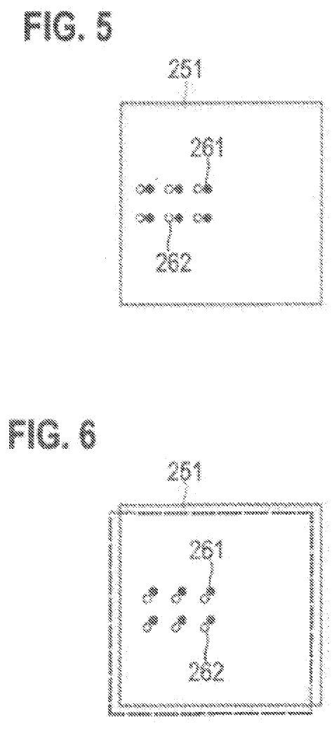

FIG. 5 illustrates aspects in relation to a change in the arrangement of the scanning points 261, 262. In the example from FIG. 5, it is clear that scanning points 262 are arranged offset with respect to scanning points 261. This could be based, for example, on odometry information, which indicates a position changes of the LIDAR system 100. In order to compensate for this position change, the offset of scanning points 261, 162 may be provided.

In the various examples described herein, one or more scan parameters of the laser scanner 101 are adapted. To ensure that the laser pulses 191 are emitted in the correct angular region and/or at the correct angles after the adaptation, a corresponding compensation based on the spontaneous movement of the LI DAR system may be helpful.

FIG. 6 illustrates aspects in relation to a change in the arrangement of scanning points 261, 262. In doing so, the example from FIG. 5 essentially corresponds to the example from FIG. 6. In the example from FIG. 6 however, scanning region 251 is shifted such that the relative arrangement of scanning points 261, 262 in relation to respective scanning region 251 is retained.

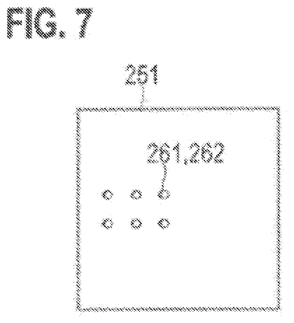

FIG. 7 illustrates aspects in relation to a change of scan parameters of the laser scanner 101. FIG. 7, in turn, illustrates scanning points 261, 262. In doing so, the emitting of the laser pulses 191 for scanning points 261 takes place with a first set of scan parameters and the emitting of the laser pulses 191 for scanning points 262 takes place with a second set of scan parameters, which is at least partially different from the first set of scan parameters.

FIG. 7 shows that the arrangement of scanning points 261, 162 is retained. In some examples, it would also be possible for a change in the arrangement to take place, for example, on the basis of odometer reading information (not shown in FIG. 7).

In FIG. 7, an angular velocity, for example, at which the laser scanner 101 the laser pulses 191 into the different angles, which correspond to scanning points 261, 262, could be modified. This means that the time between the recording of measurement data for scanning points 261 is different from the time between the recording of the measurement data for scanning points 262. At the same time however, a resolution of the corresponding LIDAR image is retained. The heating of the laser light source 111 per unit of time could thereby be decreased. Such a scenario may be desirable, for example, for comparably static objects such as buildings, vegetation, traffic signs, etc., which have been classified, e.g., by means of object detection.

A further scan parameter, which could be modified alternatively or in addition, is the strength of the various laser pulses 191.

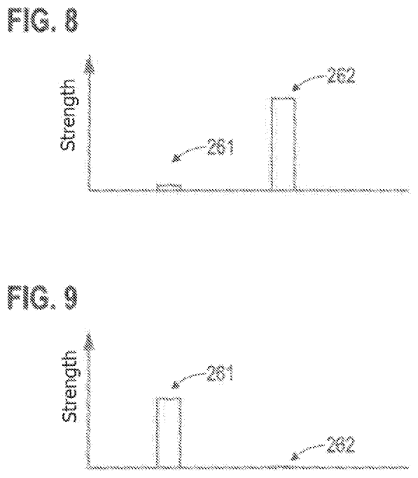

FIG. 8 illustrates aspects in relation to the changing of the strength of the laser pulses 191. In doing so, the strength of the laser pulses for scanning points 261 is substantially less than the strength of the laser pulses for scanning points 262 in the example from FIG. 8. For example, the strength of the laser pulses 191 for scanning points 262 could be greater than the strength of the laser pulses 191 for scanning points 261 by no less than a factor of 5, optionally by no less than a factor of 10, further optionally by no less than a factor of 100. For example, the laser pulses for scanning points 261 could have the same amplitude as the laser pulses for scanning points 262, for example an amplitude of no less than 50 W, optionally no less than 70 W, further optionally no less than 90 W. To do this however, the duration of the laser pulses for scanning points 262 may be significantly longer than the duration of the laser pulses for scanning points 261. For example, such a technique could then be desirable when it is determined based on the reflections 192 for scanning points 261 that there are no objects and/or no strongly reflecting objects within a close environmental range with reference to the LIDAR system 100. A greater strength can be selected for the laser pulses 191 for scanning points 262, because eye safety can also be ensured at the greater strength.

FIG. 9 illustrates aspects in relation to the changing of the strength of the laser pulses 191. In doing so, the strength of the laser pulses for scanning points 261 is substantially greater than the strength of the laser pulses for scanning points 262 in the example from FIG. 9. For example, the strength of the laser pulses for scanning points 262 could be equal to zero, i.e. it would be possible that no laser pulses 191 are emitted for scanning points 262. This may be desirable, for example, when sufficient information is available based on scanning points 261 such that emitting laser pulses 191 once again for scanning points 262 is not necessary.

In general, the controller 102 may be designed to modify the strength of the laser pulses 191 for scanning points 262 in a range of from 0% to 500% of the strength of the laser pulses 191 for scanning points 261.

The laser scanner 101 in this case can be designed to adjust the strength of the laser pulse 191 by means of an electric drive signal for at least one laser driver 116, 117 of the laser scanner and/or by means of an optical attenuator in the beam path of the laser pulses. For example, a partially reflective filter could be positioned in the beam path, with it being possible to actuate electrically or mechanically.

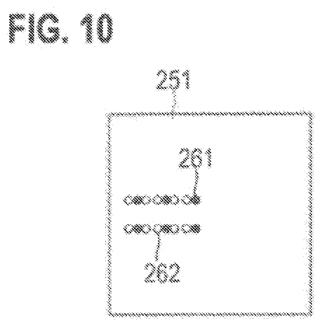

FIG. 10 illustrates aspects in relation to the changing of a scan resolution, with which the laser scanner 101 emits laser pulses 191 into different angles of the several angular region. In the example from FIG. 10, a distance between sequentially recorded and adjacent scanning points 261 is greater than a distance between sequentially recorded and adjacent scanning points 262. This can be achieved, for example, in that the laser pulses 191 which correspond to scanning points 261 are emitted to different angles at a greater angular velocity than the laser pulses 191 which correspond to scanning points 262. A repetition rate could be changed as an alternative or in addition. A resolution of the LIDAR image can thereby be controlled. In turn, eye safety can be ensured for a greater angular velocity especially well.

In the various examples described herein, the changing of the at least one scan parameter occurs on different time scales. In some examples, the changing of the at least one scan parameter can take place on a time scale of milliseconds or seconds. In other examples, the changing of the at least one scan parameter can take place on a time scale of nanoseconds or microseconds.

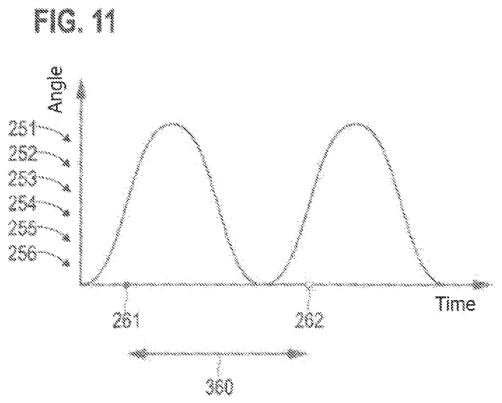

FIG. 11 illustrates aspects in relation to a time scale of the changing of the at least one scan parameter. In particular, FIG. 11 illustrates a time interval 360 between scanning point 261 which was recorded with a first set of scan parameters and scanning point 262 which was recorded with a second set of scan parameters, Both scanning points 261, 262 are arranged in the angular region 255. In the example from FIG. 11, a position of the deflector unit which corresponds to the different angular regions 251-256 is shown as a function of time. FIG. 11 shows that the deflector unit is moved periodically and continuously. A resonant laser scanner 101 can thus be implemented. In the example from FIG. 11, the time interval 360 is equal to the time period of the movement of the deflector unit. Greater time intervals 360, for example greater than two time periods or greater than 10 time periods, could also be implemented. Typical scanning frequencies are often in a range of 100 Hz or 1 kHz. Therefore, a typical time interval 360 for the example from FIG. 11 could be, for example, in a range of from 1 to 10 ms. Scanning frequencies in a range of from 5 kHz to 10 kHz would also be conceivable such that time intervals 360 in the range of >100 ps would be conceivable.

LIDAR measurements for further scanning points could be implemented between scanning points 261, 262 in the example,

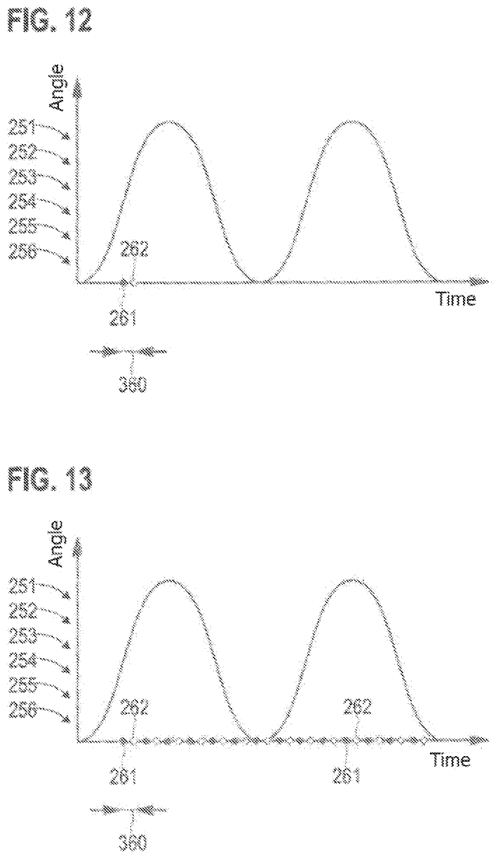

FIG. 12 illustrates aspects in relation to a time scale of the changing of the at least one scan parameter. The example from FIG. 12 essentially corresponds to the example from FIG. 11. In the example from FIG. 12 however, the time interval 360 between scanning points 261, 262 is essentially less, mainly particularly less than 1/100 of the time period of the movement of the deflector unit. In general, it is possible for the time interval 360 to be no greater than 1/1000 of the time period of the movement of the deflector unit, optionally no greater than 1/10,000, further optionally no greater than 1/100,000. For example, the LIDAR measurements for scanning points 261, 262 could be implemented directly sequentially, i.e. without further scanning points in between.

For such especially short time intervals between laser pulses 191, which are emitted with changed scan parameters, it may be desirable to carry out especially simple LIDAR measurements, for example based on the intensity or the travel time. The intensity of reflectivity may provide information on the reflectivity of a target object, with the same travel time. In addition, it may be desirable to provide multiple laser drivers 116, 117 so that laser pulses 191 can be emitted particularly close to one another in time.

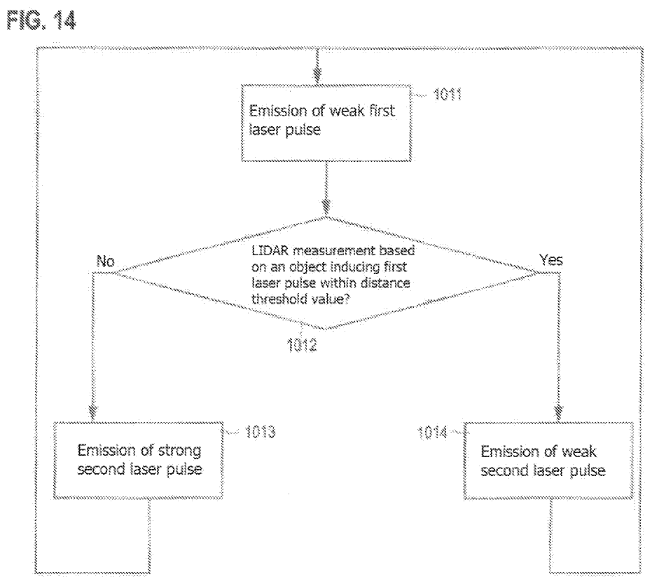

In some cases, it would be possible also that a corresponding second laser pulse with changed scanned parameters—e.g. different strengths—be available for one or more LIDAR images at least for about 10%, optionally for at least 50%, further optionally for all first laser pulses. For example, it would be possible that a first laser pulse and a second laser pulse be emitted, always alternatingly, for one or more LIDAR images. A corresponding first laser pulse can be available as a probe pulse in this manner for every other laser pulse. Such an implementation is shown in FIGS. 13 and 14. In this manner, minimal strength can be tested (1011, 1012), for example with a first laser pulse, to determine whether an object is in close range; depending on how this testing turns out, a subsequent second laser pulse is emitted at great strength (1013) or minimal strength (1014). In doing so, the second laser pulse in 1013 may be stronger than the first laser pulse in 1011. In some examples, the emitting of a second laser pulse with minimal strength could also be omitted in 1014 if, for example, sufficient information is available already from the LIDAR measurement based on the corresponding first laser pulse. It is thus possible for the controller 102 to be designed to check whether an object is in close range of the LIDAR system 100 in the corresponding angular region 251-256 for each first laser pulse 191 and/or each scanning point 261 by means of the corresponding LI DAR measurement. The controller 102 can then furthermore be designed to selectively actuate the at least one laser light source 101 based on the testing for emitting a corresponding second laser pulse 191 and/or for recording a corresponding scanning point 262. For example, close range could be defined as a distance of less than 80 m, or as a distance of less than 50 m, or as a distance of less than 20 m.

In summary, thus particularly the following examples have been described previously:

Example 1. A LIDAR system (100) comprising:
a laser scanner (101) with at least one laser light source (111), which is designed to emit laser pulses (191) into multiple angular regions (251-256), and
a controller (102), which is designed to actuate the at least one laser light source (111) in order to emit at least one first laser pulse (191) into a specific angular region (251-256) from the multiple angular regions (251-256) and to carry out a LIDAR measurement on the basis of a reflection of the at least one first laser pulse (191),
wherein the controller (102) is additionally designed to change at least one scan parameter of the laser scanner (101) on the basis of the LIDAR measurement and to then selectively actuate the at least one laser light source (111) so as to emit at least one second laser pulse (191) into the specific angular region (251-256).

Example 2. The LIDAR system (100) according to Example 1,
wherein the at least one scan parameter is selected from the following group; a strength of the laser pulses (191); a repetition rate of the laser pulses (191); a geometry of a superimposed figure of the scanning in a first scanning axis and of the scanning in a second scanning axis; and an angular velocity at which the laser scanner (101) emits laser pulses (191) into different angles of the multiple angular regions (251-256).

Example 3. The LIDAR system (100) according to Example 1 or 2,
wherein the controller (102) is designed to modify a strength of the at least one second laser pulse (191) compared to a strength of the at least one first laser pulse (191) based on the LIDAR measurement,
wherein the strength of the at least one second laser pulse (191) is greater than the strength of the at least one first laser pulse (191) by no less than a factor of 5, optionally by no less than a factor of 10, further optionally by no less than a factor of 100,
wherein the controller (102) is designed to change the strength of the at least one second laser pulse (191) within a range of 0%-500% of the strength of the at least one first laser pulse (191).

Example 4. The LIDAR system (100) according to Example 3,
wherein the LIDAR measurement determines at least one of an intensity and a travel time of the reflection of the at least one first laser pulse (191),
wherein the controller (102) is designed to determine the strength of the at least one second laser pulse (191) based on at least one of intensity and the travel time of the reflection of the at least one first laser pulse (191).

Example 5. The LIDAR system (100) according to any of the preceding examples, wherein the LIDAR measurement determines a type of an object in the specific angular region (251-256) by means of object detection,
wherein the controller (102) is designed to change the scan parameter based on the type of object.

Example 6. The LIDAR system (100) according to any of the preceding examples,
wherein the laser scanner (101) comprises a continuously and periodically moved deflector unit,
wherein a time interval between a last laser pulse of the at least one first laser pulse (191) and a first laser pulse of the at least one second laser pulse (191) is no greater than 1/1000 of a time period of the movement of the deflector unit, optionally no greater than 1/10,000, further optionally no greater than 1/100,000.

Example 7. The LIDAR system (100) according to any of Examples 1-5,
wherein the laser scanner (101) comprises a continuously and periodically moved deflector unit,
wherein a time interval (360) between a last laser pulse of the at least one first laser pulse (191) and a first laser pulse (191) of the at least one second laser pulse (191) is greater than half the time period of the movement of the deflector unit, optionally greater than one time period, further optionally greater than 10 time periods.

Example 8. The LIDAR system (100) according to any of the preceding examples,
wherein the laser scanner (101) comprises a first laser driver (116, 117) with a first storage device for electrical energy and a second laser driver (116, 117) with a second storage device for electrical energy,
wherein the controller (102) is designed to actuate the first laser driver (116, 117) for emitting the at least one first laser pulse (191) and to actuate the second laser driver (116, 117) for emitting the at least one second laser pulse (191).

Example 9. The LIDAR system (100) according to any of the preceding examples,
wherein at least one first angle of the specific angular region (251-256), in which the at least one first laser pulse is emitted, is at least partially different from at least one second angle of the specific angular region (251-256), in which the at least one second laser pulse is emitted,
wherein the controller (102) is designed to determine an arrangement of the at least one second angle in relation to the at least one first angle based on odometer information for the LIDAR system (100).

Example 10. The LIDAR system (100) according to any of the preceding examples,
wherein the controller (102) is designed to check whether an object is in close range of the LIDAR system (100) in the corresponding angular region (251-256) for each first laser pulse (191) of the at least one first laser pulse (191) by means of the corresponding LIDAR measurement,
wherein the controller (102) is further designed to selectively actuate the at least one laser light source (101) based on the check as to whether an object is in close range of the LIDAR system (100) in the corresponding angular region (251-256) in order to emit a corresponding second laser light pulse of the at least one second laser pulse (191).

Example 11. A method comprising:
actuation of at least one laser light source (111) of a laser scanner (101) for emitting at least one first laser pulse (191) into a specific angular region (251-256) from multiple angular regions (251-256),
implementation of a LIDAR measurement based on a reflection of the least one first laser pulse (191),
based on the LIDAR measurement: modification of at least one scan parameter of the laser scanner (101), and
selective actuation of the at least one laser light source (111) for emitting at least one second laser pulse (191) into the specific angular region (251-256).

Obviously, the features of the previously described embodiments and aspects of the invention can be combined with one another. In particular, the features cannot only be used in the described combinations but also in other combinations or in isolation without extending beyond the scope of the invention.

1. A light detection and ranging (LIDAR) system comprising:
a laser scanner comprising at least one laser light source configured to emit laser pulses into multiple angular regions, and
a controller configured to actuate the at least one laser light source in order to emit at least one first laser pulse into a specific angular region of the multiple angular regions and to carry out a LIDAR measurement based on a reflection of the at least one first laser pulse,
wherein the controller is configured to change at least one scan parameter of the laser scanner based on the LIDAR measurement and to then selectively actuate the at least one laser light source to emit at least one second laser pulse into the specific angular region,
wherein the at least one scan parameter comprises a strength of the laser pulses, wherein the laser scanner comprises a continuously and periodically moved deflector unit,
wherein a time interval between a last laser pulse of the at least one first laser pulse and a first laser pulse of the at least one second laser pulse is no greater than 1/1000 of a time period of a movement of the deflector unit, optionally no greater than 1/10,000, further optionally no greater than 1/100,000,
wherein the controller is configured to modify the strength of the at least one second laser pulse compared to a strength of the at least one first laser pulse based on the LIDAR measurement, and
wherein the strength of the at least one second laser pulse is greater than the strength of the at least one first laser pulse by no less than a factor of 5.

2. The LIDAR system according to claim 1,
wherein the LIDAR measurement determines at least one of an intensity and a travel time of the reflection of the at least one first laser pulse, and
wherein the controller is configured to determine the strength of the at least one second laser pulse based on at least one of the intensity and the travel time of the reflection of the at least one first laser pulse.

3. The LIDAR system according to claim 1,
wherein the controller is configured to check whether an object is in close range of the LIDAR system in the corresponding angular region for each first laser pulse of the at least one first laser pulse based on the corresponding LIDAR measurement,
wherein the controller is further configured to selectively actuate the at least one laser light source based on the check whether an object is in close range of the LIDAR system in the corresponding angular region in order to emit a corresponding second laser pulse of the at least one second laser pulse.

4. The LIDAR system according to claim 3, wherein the controller is further configured to actuate the at least one laser light source to then emit the corresponding second laser pulse of the at least one second laser pulse only when there is no object in close range of the LIDAR system.

5. The LIDAR system according to claim 1,
wherein the laser scanner comprises a first laser driver with a first storage device for electrical energy and a second laser driver with a second storage device for electrical energy, and
wherein the controller is configured to actuate the first laser driver for emitting the at least one first laser pulse and to actuate the second laser driver for emitting the at least one second laser pulse.

6. The LIDAR system according to claim 5,
wherein the time interval between a last laser pulse of the at least one first laser pulse and a first laser pulse of the at least one second laser pulse is less than a time required for charging the electrical energy storage device of the first laser driver.

7. The LIDAR system according to claim 1,
wherein the at least one scan parameter further comprises: a repetition rate of the laser pulses.

8. The LIDAR system according to claim 1, wherein the at least one scan parameter further comprises: a geometry of a superimposed figure of the scanning in a first scanning axis and of the scanning in a second scanning axis.

9. The LIDAR system according to claim 1, wherein the at least one scan parameter further comprises:
an angular velocity at which the laser scanner emits laser pulses into different angles of the multiple angular regions.

10. The LIDAR system according to claim 1,
wherein the LIDAR measurement determines a type of an object in the specific angular region by means of object detection, and
wherein the controller is configured to change the scan parameter based on the type of object.

11. The LIDAR system according to claim 1,
wherein at least one first angle of the specific angular region, in which the at least one first laser pulse is emitted, is at least partially different from at least one second angle of the specific angular region, in which the at least one second laser pulse is emitted, and
wherein the controller is configured to determine an arrangement of the at least one second angle in relation to the at least one first angle based on odometer information for the LIDAR system.

12. The LIDAR system according to claim 1, wherein the laser scanner is designed to operate resonantly about different degrees of freedom of movement for scanning the laser light.

13. A method comprising:
actuating at least one laser light source of a laser scanner for emitting at least one first laser pulse into a specific angular region from multiple angular regions,
implementing a LIDAR measurement based on a reflection of the least one first laser pulse,
based on the LIDAR measurement:
modifying at least one scan parameter of the laser scanner, and
selectively actuating the at least one laser light source for emitting at least one second laser pulse into the specific angular region using the modified at least one scan parameter.
